(19) United States
(12) Patent Application Publication
(10) Pub. No.: US 2010/0030564 A1
(43) Pub. Date: Feb. 4, 2010

(54) SYSTEM AND METHOD FOR CONDUCTING A FUNDRAISING RAFFLE

(75) Inventor: George A. Castineiras, Farmington, CT (US)

Correspondence Address: MICHAUD-Kinney Group LLP, 306 INDUSTRIAL PARK ROAD, SUITE 206, MIDDLETOWN, CT, 06457, US

(73) Assignee: CASTINEIRAS COMPANIES, LLC, Farmington, CT (US)

(21) Appl. No.: 12/181,630

(22) Filed: Jul. 29, 2008

(51) Int. Cl. G06Q 30/00; A63F 9/24

(52) U.S. Cl. 705/1; 463/16

(57) ABSTRACT

Funds are raised by raffle by forming a raffle venture between a sponsor and a fundraiser. The fundraiser offers raffle tickets to others, collects raffle revenue, arranges a drawing to select a winner. The revenue is distributed as a jackpot to the winner and as gain to the sponsor. The sponsor may identify contacts and the fundraiser may send to the contacts promotional messages for the raffle. The promotional messages may be composed by, or merely previewed and edited by, the sponsor. The raffle venture may specify initial proportions for distribution of revenue to the sponsor and the fundraiser. The proportions may be adjusted before the drawing. The method may be practiced via a website and may include establishing a sponsor web page that optionally contains content uploaded by the sponsor. There may be a blog site, an online social networking site and a webcast of the drawing.

### BACKGROUND OF THE INVENTION

1. Field of the Invention

This invention relates generally to systems and methods for conducting a fundraiser and, in particular, to systems and methods for conducting a fundraising raffle for the benefit of others.

2. Description of Related Art

Traditional methods of conducting a fundraising event for organizations include, for example, bake sales, candy sales, product sales, raffles and solicitations for cash contributions. Often, these methods are promoted and/or carried out by volunteers who personally approach potential contributors. Such methods are highly labor-intensive and limited, since the extent to which volunteers can be asked to make such efforts is limited. Typically, the volunteers are members of the raffle sponsor. In addition, fundraising efforts can be tedious and/or time-consuming.

In some cases, volunteers are limited in their ability to promote fundraising efforts. For example, organizations within a secondary school (drama clubs, choirs, marching bands, athletic teams, and the like) often recruit students to raise funds for various activities, but the school may be reluctant to appear to be endorsing the consumption of unhealthy snacks such as candy, or to pressure students to engage in door-to-door solicitation.

Based on the foregoing, it is the general object of this invention to provide systems and methods for conducting fundraising that improve upon, or overcome the problems and drawbacks of, prior art systems and methods for conducting fundraising.

### SUMMARY OF THE INVENTION

The present invention resides in one aspect in a method for conducting a fundraising event to raise funds for a raffle sponsor. The method includes forming a fundraising venture between a promoter and the raffle sponsor wherein purchases of raffle tickets by customers benefit the raffle sponsor. The promoter offers tickets for sale, receives payments from customers for the tickets; and shares a portion of the payments with the raffle sponsor.

According to one aspect of the invention, the method may include maintaining a fundraising website accessible to customers via the Internet where customers can purchase and pay for raffle tickets.

Another aspect of the invention relates to offering to the raffle sponsor promotional material that promotes the raffle at the fundraising website for the benefit of the raffle sponsor. The raffle sponsor and/or the promoter may send the promotional material to potential customers.

Various other optional aspects of the invention include allowing raffle sponsors and customers to register, asking registered customers to invite third parties to become registered customers. The method may include offering customers an incentive to register, wherein the incentive comprises a gift to the customer in return for making a stated number or amount of purchases. The method may include providing a blogging site and/or a social networking site for customers and/or raffle sponsor contacts.

### BRIEF DESCRIPTION OF THE DRAWINGS

The features and advantages of the present invention will be better understood when the Detailed Description of the Preferred Embodiments given below is considered in conjunction with the figures provided, wherein:

FIG. 1 is a simplified block diagram of a system for conducting a fundraising event in accordance with one embodiment of the present invention; and

FIG. 2 is a simplified flow diagram depicting a method for registering a raffle sponsor such that a fundraising event may be conducted for the raffle sponsor, in accordance with one embodiment of the present invention.

In these figures like structures are assigned like reference numerals, but may not be referenced in the description of all figures.

### DESCRIPTION OF PREFERRED EMBODIMENTS OF THE INVENTION

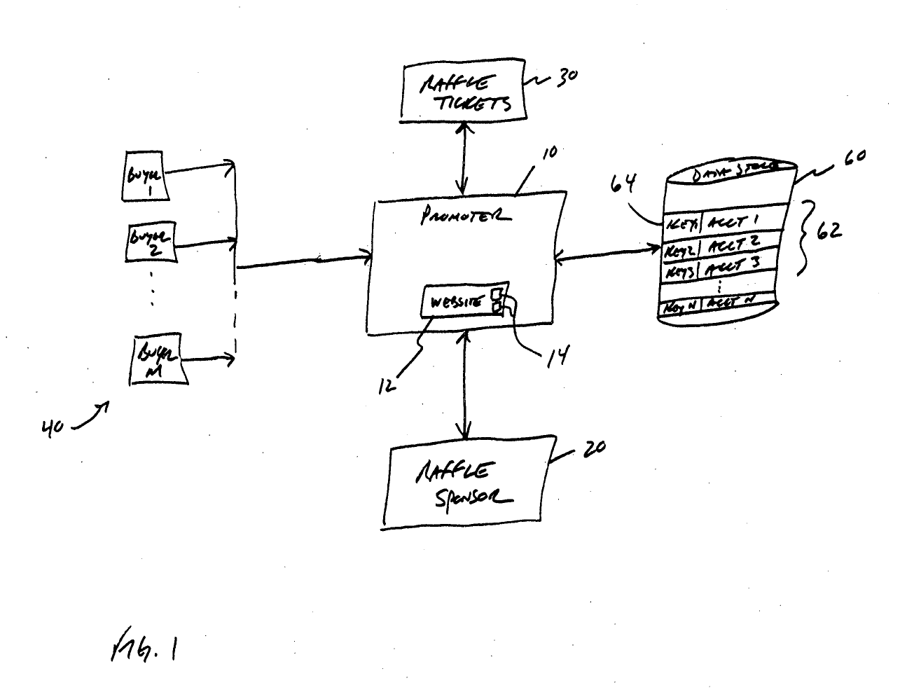

In accordance with one embodiment of the present invention illustrated in FIG. 1, a company or promoter 10 assists a raffle sponsor 20 in conducting an event to raise funds by means of a raffle. The raffle sponsor 20 may wish to raise funds for its own use and may be, for example, a nonprofit organization such as a church, charity or an educational institution (e.g., a K-12 grade school), or the raffle sponsor 20 may be an individual who wishes to support a particular cause (e.g., an affinity group).

When the promoter 10 and the raffle sponsor 20 agree to terms under which a fundraising event is to be conducted, namely, a raffle to benefit the raffle sponsor 20, a fundraising or raffle venture is formed between the promoter 10 and the raffle sponsor 20. Typically, the fundraising venture raises funds by conducting a raffle, where conducting the raffle includes offering raffle tickets 30 for sale to third party buyers 40, collecting payments for the tickets 30 from the third party buyers 40 (the payments representing raffle revenue), sharing a portion of the raffle revenue collected by the promoter 10 between the promoter 10 and the raffle sponsor 20 according to the terms of the fundraising venture, and completing the raffle and distributing “winnings” to a selected buyer. As used herein, the term “raffle ticket” means an opportunity or chance to be selected from among other participants in the raffle to win a prize, whether or not that opportunity or chance is represented by a physical ticket as is depicted in FIG. 1 at 30.

The promoter 10 arranges for a raffle drawing and for payout of the raffle revenue according to the terms of the raffle venture. In a simple example of such a raffle, each raffle ticket 30 is sold at a predetermined price and the prize is a jackpot (e.g., money, products, and the like) derived from or purchased with, a portion of the raffle revenue received from the sale of raffle tickets 30. However, raffles may be conducted in various other ways, some of which are described herein by way of non-limiting examples. In one embodiment, some or all aspects of the fundraising venture may be formed and/or carried out over the Internet by means of a website 12 (a “fundraising website”) that is accessible by the raffle sponsor 20 and the third party buyers 40 through the use of a computing device operating internet browser software, as is generally known in the art. Conversely, many features of the raffle venture that can be provided via a website may also be practiced off-line.

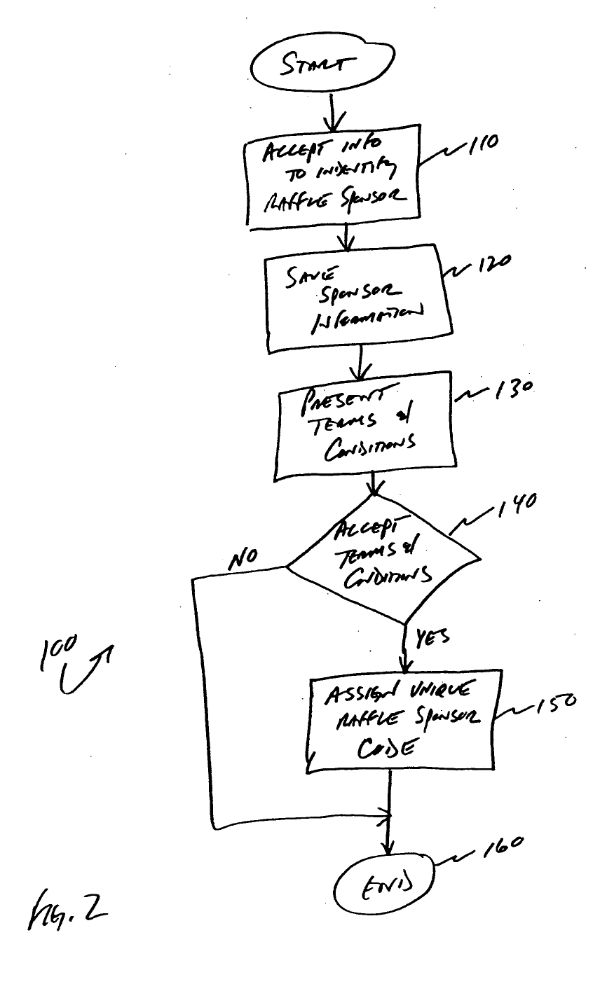

To allow the raffle sponsor 20 to form the fundraising venture online the fundraising website 12 is configured to include a process referred to herein as “raffle sponsor registration.” FIG. 2 depicts a raffle sponsor registration process 100 in accordance with one embodiment of the present invention. In Step 110 of the raffle sponsor registration process 100, the raffle sponsor 20 provides information needed to uniquely identify the raffle sponsor 20. For example, in the case of a raffle sponsor 20 that is a school, the information to uniquely identify the school includes, for example, the name of the school, its address, a school administrator or other person that can represent the school's interest in establishing and conducting the fundraising event, and contact information including a telephone number and/or email address. At Step 120, the raffle sponsor information is optionally stored as a record in a data store 60 operatively coupled to the fundraising website 12. At Step 130, terms and conditions for conducting the fundraising venture between the promoter 10 and the raffle sponsor 20 are presented to the raffle sponsor 20 for review and approval. In one embodiment, the fundraising website 12 includes a virtual administrator (not shown) that guides the raffle sponsor 20 though the raffle sponsor registration process and provides, for example, answers to commonly asked questions. In yet another embodiment, the promoter 10 provides a toll-free telephone help line (if needed) to assist the raffle sponsor 20 during the raffle sponsor registration process 100 and/or during the course of conducting the fundraising venture. In one embodiment, the raffle sponsor registration process 100 includes a Step 140 whereby the raffle sponsor 20 indicates acceptance of the terms and conditions of the fundraising venture before the venture is formed between the promoter 10 and the raffle sponsor 20. If the raffle sponsor 20 rejects the terms and conditions, the registration process 100 ends at Step 160. If the raffle sponsor indicates acceptance of the terms of the fundraising venture, the raffle sponsor registration process 100 continues from Step 140 to Step 150. At Step 150, the raffle sponsor 20 is assigned a unique raffle sponsor code.

In one embodiment, at Step 150 a registration fee is payable to the promoter 10 by or on behalf of the raffle sponsor 20 to complete the raffle sponsor registration process 100. In one embodiment, the registration fee is collected electronically by credit card transaction, electronic check, wire transfer or the like. The raffle sponsor code remains active for a predetermined period of time such as, for example, one year, or as long as one or both of the promoter 10 and the raffle sponsor 20 wish to continue the fundraising venture. Optionally, the terms of the fundraising venture may include a discount in the registration fee paid by the raffle sponsor 20 based on, for example, the longevity of the fundraising venture relationship.

As described in detail below, in one embodiment the data store 60 includes a plurality of accounts 62 that, for example, each correspond to a unique one of the raffle sponsors 20. In one embodiment, the raffle sponsor code is a key 64 to the account corresponding to the raffle sponsor 20. The plurality of accounts 62 allow the fundraising website 12 to credit purchases of raffle tickets 30 to a raffle sponsor account 62 when a third party buyer 40 purchases one or more tickets 30 for the raffle to benefit the raffle sponsor 20. The promoter 10 deposits raffle ticket revenue into the account 62. In one embodiment, the raffle sponsor account 62 may be divided into numerous sub-accounts, there being a sub-account for each raffle that a raffle sponsor conducts. The raffle sponsor account 62, including any sub-accounts, is administered by the promoter 10 or a third party trustee as agent for the promoter 10. Revenue is distributed from the raffle sponsor account 62 according to the terms of the fundraising venture. Optionally, the raffle sponsor account 62 may be an interest-bearing account and interest accrued on funds therein may be retained by the promoter 10 as part of a service fee for administering the accounts 62.

In one embodiment, a fundraising raffle is conducted as follows. On a specified date, a drawing is held and at least one winner is selected. The selection process is referred to herein as the “drawing” and the specified date may be referred to as a “drawing date.” In accordance with one embodiment of the present invention, the drawing (e.g., selection of a winning raffle ticket 30) may be performed using the latest technology to secure a truly random and, thus, fair selection of the winning raffle ticket from among all raffle tickets 30 purchased. In one embodiment, the drawing may entail a computerized method for identifying a winning raffle ticket 30 or participant, e.g., by the computerized selection of a winning raffle ticket number. In another embodiment, the drawing may include a physical drawing of a ticket 30 or other physical token from an assemblage of such tickets or tokens that represent the raffle participants and/or raffle tickets. It should be appreciated that, in one embodiment, the drawing process is audited as necessary or as desired by a third party, unaffiliated person or entity.

Once the raffle winner(s) is identified, at least part of the raffle revenue is released to the raffle winner (if cash is the raffle prize) and to the raffle sponsor 20. The promoter 10 may also receive a part of the raffle revenue as a service fee (as described in detail below). For example, after the expenses of the raffle are paid from the raffle revenue (e.g., payment to an external auditor), the promoter 10 may receive a part of the raffle revenue, for example, about one percent (1%) of the raffle revenue. The remaining part of the raffle revenue may be shared by the raffle sponsor 20 and the raffle winner in predetermined proportions, for example, in even shares.

A number of optional features may be included in accordance with the present invention. For example, the raffle venture may have a stated, limited duration. Optionally, the raffle venture may permit the raffle sponsor 20 to sponsor a number of raffles and to specify timing of the raffles during the term of the venture (e.g., once a year, twice a year, every three months, weekly, etc.). Additionally, the terms of the raffle venture may permit the raffle sponsor 20 to specify pricing of raffle ticket 30, for example, raffle ticket denominations of $1, $2, $5, $10 or more; the number of raffle tickets that may be sold in any one raffle (e.g., a predetermined number of tickets to limited chances to win, or provide an unlimited number of chances to win) for the drawing period and the allocation of the raffle revenue for distribution to the raffle winner and the raffle sponsor 20, e.g., split raffle revenue fifty percent each (50/50) or in favor of either the raffle winner or raffle sponsor in other percentages such as 60/40 in favor of the winner, 40/60 in favor of the raffle sponsor 20, 70/30, or other percentage as are agreed upon as part of the terms and conditions of the raffle venture. In addition, a registration fee may be charged to participate in the raffle. Moreover, in order to incentivize a sponsor, matching gifts can also be provided. The raffles can also include a minimum sign up period thereby allowing sufficient time to have an adequate number of participants in the raffle.

In one embodiment, the promoter 10 provides promotional materials corresponding to the fundraising event, the raffle sponsor 20, and the like, that the raffle sponsor 20 forwards the promotional materials to third party buyers 40 (or potential third party buyers). For example, the promoter 10 (via the fundraising website 12) provides the raffle sponsor 20 with access to the promotional materials including tools, marketing promotions, and a suggested promotion strategy, and the raffle sponsor 20 uses the tools, promotions, and the like to initiate the fundraising event. In one embodiment, the promoter 10 may optionally provide an electronic mail (email) message as a reminder to the raffle sponsor 20 to send an email messages promoting the fundraising event to the raffle sponsor's contacts. A recommended frequency of distributing such promotional messages may include, for example, distributing two email messages per month during the course of a fundraising event to encourage sales of raffle tickets. In one embodiment, the promotional message may include an attached suggested promotional message for use by the raffle sponsor 20. In one embodiment, the promotional messages may notify the raffle sponsor 20 at predetermined time periods such as, for example, about one week in advance of a prescribed release. As can be appreciated, each raffle sponsor 20 independently determines if they want to send the email promotion within the recommended timeframes or not at all. Similarly, in one embodiment the promoter 10 may allow the raffle sponsor 20 to preview, edit, and/or approve the promotional message before distribution to third party buyers 40. In one embodiment, the promoter 10 may forward to the third party buyers 40 a promotional message composed by the raffle sponsor 20.

In one embodiment, email promotional messages may be provided by the promoter 10 in traditional text format and/or in HTML format (as is known in the art) and may include animated announcements from a pre-selected promotional personality such as, for example, personality characteristics of well known human or animated characters. A variety of formats may be employed, and the promotional personalities may be used randomly to drive the third party/customer interest up when they are sent. The timing and content of promotional message may also be bases around key holidays such as Valentines Day, Mothers Day, Fathers Day, Christmas, Hanukah, and the like.

In one aspect of the invention, the promoter 10 may offer to promote sales of the raffle tickets 30 for a fee. In one embodiment, the raffle sponsor 20 conveys to the promoter 10 contact information for a list of third party buyers 40 that the raffle sponsor 20 believes may have interest in purchasing tickets (referred to herein as “raffle sponsor contacts”). The raffle sponsor 20 contacts may include past or likely future contributors to the raffle sponsor 20. If the raffle sponsor 20 is an organization, raffle sponsor contacts may include, for example, members of the organization. If the raffle sponsor 20 is a primary or secondary school, the raffle sponsor contacts may include, for example, parents of the students attending the school. The promoter 10 may then participate in promoting the sale of raffle tickets 30 by sending promotional messages directly to raffle sponsor contacts and/or other third parties. School parent teacher organizations (PTO) can sponsor raffles and promote them to the school(s) they represent.

In one internet-based embodiment of this invention, the fundraising website 12 allows the raffle sponsor 20 to choose whether, or to what extent, to authorize the promoter 10 to directly communicate with third party buyers 40 regarding the sale of raffle tickets 30 to benefit the raffle sponsor 20. For example, the fundraising website 12 may be configured to allow the raffle sponsor 20 to upload an electronic list of raffle sponsor contacts (preferably with contact information that includes email addresses) and to allow the raffle sponsor 20 to request (optionally, for a fee) an automated promotion package. The automated promotion package periodically promotes the sale of raffle tickets 30 to the raffle sponsor contacts by distributing email messages to the raffle sponsor contacts. In one embodiment, the promotional emails (or other types of communication) to the raffle sponsor contacts are customized to the raffle sponsor and/or specific fundraising event and may include details such as the raffle sponsor's name, logo, special incentives and promotions, etc.

Alternatively, or in addition to the foregoing promotion strategies, the promoter 10 may promote sales of raffle tickets 30 to the third parties 40 independently from the raffle sponsor 20.

Raffle ticket sales may be promoted in various ways, including increasing the raffle prize and/or discounting the ticket price. For example, the proportion of the revenue that will go to the jackpot may be increased with increased ticket sales, by agreement of the raffle sponsor 20 and/or the promoter 10 to take a smaller proportion of the revenue as sales increase. Alternatively, the raffle sponsor 20 and/or the promoter 10 may offer a prize in addition to the jackpot. The prize may be something that was donated to the organization for use in the raffle. For example, the raffle sponsor 20 may advertise that after, for example, about one thousand dollars ($1,000) in raffle ticket sales, the prize will include a one hundred dollar ($100) gift card to a major department store; after, for example, about five thousand dollars ($5,000) in ticket sales the prize will include a weekend getaway; after about twenty-five thousand dollars ($25,000) a car, etc. Fulfillment of such promises of addition prizes would be the responsibility of the raffle sponsor 20 and not the promoter 10.

Alternatively, or in addition to the foregoing promotion efforts, incentives may be offered to encourage the purchase of raffle tickets 30. For example, discounts may be given for multiple ticket purchases, or “free tickets” may be given with a specified number of purchased raffle tickets.

In one embodiment, an incentive for raffle ticket buyers may be based on the buyer's performance of a certain act or attainment of a particular goal selected by the raffle sponsor (or based on the raffle ticket buyer's relationship with someone who performs the act or attains the goal). For example, a bonus ticket may be made available to raffle ticket buyers who, by themselves or through a relation (such as a child), attain a specified academic achievement (e.g., attaining a particular grade point average or a particular maximum score on a test such as the SAT; attaining college acceptance; being published; receiving a diploma; being named on a school Honor roll, etc.), participates in a selected activity (for example, enrolling in a formal exercise program or on a school athletic team or an athletic event), or who achieve a stated health criterion (for example, a loss of weight; good oral hygiene as evidenced by a check-up with no cavities found; achievement and /or maintenance of a desirable height/weight/muscle index, etc.).

It should be appreciated that when initiating a purchase of raffle tickets 30 via the fundraising website 12, the fundraising website 12 is configured to request that the third party buyer initiating the purchase enters the unique raffle sponsor code (described above in the aforementioned registration process) corresponding to the raffle sponsor 20 that the third party buyer 40 wishes to support by means of the raffle ticket purchase. As can be appreciated, the raffle sponsor code ensures that the correct raffle sponsor account 62 is credited for the raffle ticket sale. Raffles can also be available to the general public. Individuals or institutions can view the raffle and the odds and decide whether or not they want to play.

In one embodiment, the process of selling raffle tickets 30 may include collecting and recording personal profile information about raffle ticket buyers 40. The personal profile information may be used to select raffle ticket buyers 40 to receive, or gain access to, special offers and promotions pertaining to the raffle venture or to other things. In one embodiment, the promoter 10 invites buyers of raffle tickets to register with the promoter 10 as customers, and the registration process may require the buyer/customer to provide more personal profile information than is required to buy a raffle ticket. In one embodiment, customer registration may be offered to non-buyers as well. By purchasing a raffle ticket 30 or by indicating a raffle sponsor 20 upon registration, a registered customer becomes associated with a raffle sponsor 20. In return for completing registration, a raffle ticket buyer 40 may be offered a discount on his/her ticket purchase, and may be selected to receive offers and information not provided to others. The promoter 10 may offer raffle incentives for customer registration. For example, the promoter 10 may offer to add a stated dollar amount to a jackpot of a raffle sponsor 20 for every about thirty (30) customer registrants associated with that raffle sponsor 20.

In one embodiment, the fundraising website 12 is configured for interactive use by raffle ticket buyers 40 and other third parties. For raffle ticket buyers, the fundraising website 12 is configured to require as a condition of purchase that the raffle ticket buyer 40 agrees to the necessary terms and conditions of the raffle such as, for example, to receive payment and to provide personal profile information consisting at least of contact information. For example, the fundraising website 12 is configured to collect wire transfer data to electronically transfer the ticket revenue to an account for the raffle sponsor 20. The fundraising website 12 is configured to collect and store personal profile information about the raffle ticket buyer as well. The raffle ticket buyer will receive a confirmation email from (or on behalf of) the raffle sponsor 20 of the raffle ticket purchase.

In one embodiment, the fundraising website 12 includes a plurality of web pages 14, each web page being dedicated to one of the registered raffle sponsors 20. The dedicated raffle sponsor web page (e.g., a “raffle sponsor web page”) includes, for example, a description of the raffle sponsor 20 and a description of the one or more raffles being conducted by the raffle sponsor 20. In one embodiment, the raffle sponsor 20 participates in the construction and maintenance of the raffle sponsor web page by, for example, entering and/or uploading content to the raffle sponsor web page on an initial or periodic basis. In one embodiment, the fundraising website 12 is configured to include one or more templates that can be retrieved and modified by individual raffle sponsors to “customize” its own raffle sponsor web page.

In one embodiment, the promoter 10 may invite third party buyers 40 to register with the promoter 10 (optionally via the fundraising website 12) under a customer registration process (similar to the registration process 100). The customer registration process may optionally require the third party provides more personal profile information than is required to buy a raffle ticket 30. The customer registration may be offered to non-buyers as well. By purchasing a raffle ticket or by indicating a raffle sponsor during the customer registration process, a registered customer becomes associated with a raffle sponsor 20. Optionally, a confirmation notice for a purchase of a raffle ticket 30 may invite a buyer to register as a customer and to extend the invitation to register to others such as friends and family. Customers may register at the fundraising website 12 through a very interactive, entertaining and engaging process. This may include an animated registration personality to assist the customer in the registration process. In one embodiment, the customer registration process includes an assent to the terms and conditions of the fundraising website 12.

In one embodiment, the fundraising website 12 is used to provide registered customers (e.g., the third parties 40) at least some, optionally all, of the features of registration. For example, registered customers may be provided access to important discounts and special offers that are available on a national level, regional level, and at a personal level based on the customer's profile. Registration may include an opportunity to store credit card information. The credit card may be the primary medium for the registered customer to purchase raffle tickets and receive cash prizes. A registered customer can make a one-time purchase, or credit card information may be stored by the fundraising website 12 (e.g., in a customer record in the data store 60) to facilitate future purchases of raffle tickets by that customer over time. If a registered customer wins a raffle, for example, a credit entry is automatically made to the customer's credit card account. Alternatively, a check may be issued in payment of the raffle. An incentive to register may include free items, or rebates on tickets purchased ($1 back after 10 tickets are purchased, etc.).

In one embodiment, the fundraising website 12 may offer the third parties 40 (such as registered customers) and, optionally, to unregistered customers, access to a topic-specific blog site and/or to an online social network. Blog topics may include, for example, one or more of education, fundraising, homework assistance, raising children, help needed when moving to a new area, and the like. Registered customers may have access to new product promotions, discounts, services, and the like. The registered customers may also be able to select one or more preferences for receiving relevant promotions (e.g., by direct mail, electronic mail, or both) rather than receiving all promotions that can be seen as merely being inundated with “junk mail.”

In one embodiment, on a drawing date all raffle ticket buyers 40 are given a time and log-in details for the fundraising event. Attending the drawing is optional for ticket buyers. However, the notice is seen to permit creation of an on-line, “live” splash announcement highlighting one or more of the amounts won in the raffle, the individual(s) who won the raffle, the amount the raffle sponsor organization raised, and congratulations to all who participated. Optionally, the fundraising website 12 may be configured to record purchases of raffle tickets 30 and to perform a drawing by randomly selecting one or more winners from among the purchasers. The winner will be notified via email (and/or by a telephone call) and will be given the details of how to receive their wining and preferably, how to process the winnings back into the credit card account maintained at the fundraising website 12. In one embodiment, winners are also given an opportunity to donate some or all of their winnings back to the raffle sponsor 20. In one embodiment, conclusion of a drawing may also trigger the beginning of a new raffle with new incentives.

In one embodiment, the fundraising website 12 may be configured to implement variable financial aspects of the raffle venture, some of which may be promotions as described herein. For example, the website 12 may be configured to store a revenue-sharing formula that is established as part of the raffle or fundraising venture. The revenue-sharing formula may include, for example, one or more revenue-sharing factors that specify the portion of the raffle revenue that is kept by the promoter 10, and that is distributed to the raffle sponsor 20 and/or the raffle winner(s). Optionally, the fundraising venture may require that one or more revenue-sharing factors include an initial value or distribution portion that changes in a predetermined way at or before the drawing. For example, the fundraising venture may require that the raffle sponsor's portion of the net revenue starts at an initial value of, for example, about fifty percent (50%) and is reduced to forty-five percent (45%) when revenue collected reaches a first predetermined threshold of, for example, about ten thousand dollars ($10,000.00), and is further reduced to forty percent (40%) when the revenue collected reaches a second predetermined threshold of about twenty thousand dollars ($20,000.00). The fundraising website 12 stores the initial sponsor's portion value, tracks accumulated revenue collected from ticket sales, and makes adjustments to the sponsor's portion value as the appropriate threshold levels are reached. After the drawing, the adjusted revenue-sharing factors are used to determine how the raffle revenue is distributed.

The fundraising website 12 may also generate income in conventional ways such as, for example, by displaying advertising (e.g., banner ads), sponsored links, and the like. Such income may go exclusively to the promoter 10 or may be shared with one or more of the raffle sponsors 20.

One embodiment of conducting a preferred fundraising event follows.

A school organization, as a raffle sponsor 20 (e.g., “The ABC School”), enters into a fundraising venture with the promoter 10. Third party buyers 40 purchase raffle tickets online at the fundraising website 12 and/or at a web page dedicated to the ABC School. The purchases include a raffle sponsor code that uniquely identifies the raffle sponsor to the promoter 10. Payments for purchases by the customers are made directly to the promoter 10 and transferred to an on-line account registered by and assigned to the ABC School (e.g., one of the plurality of accounts 62) to hold raffle revenue pertaining to the ABC School. As described above, the account retains the raffle revenue until a predetermined time for disbursement, e.g., on or after the drawing date. Any interest earned on the account is retained by the promoter 10 as a fee for administering the accounts 62 and/or as a source of revenue. The promoter 10 records and periodically audits revenue flow and the plurality of accounts 62. While acting in an administrator capacity, the promoter 10 does not have authority to withdraw raffle revenue from the ABC School account except as defined under the terms and conditions of the merchandising agreement formed between the promoter 10 and the ABC School as the raffle sponsor 20.

In the exemplary fundraising event, the terms of the raffle venture are that payment to the promoter 10 is one percent (1%) of the raffle revenue, plus earned interest. The raffle sponsor 20 splits the remaining revenue on a 50/50 basis with the raffle winner(s). Further, it is assumed that the ABC School has three divisions, each division having a sub-account within one master account. The ABC School sponsors a first raffle to benefit a first division of The ABC School (e.g., the school choir) which total raffle ticket sales of $5,000 and interest accrued to date of $50, for a total of $5,050 in a sub-account associated exclusively with that division (the school choir) of the ABC School. For the first raffle, a drawing date is set at Mar. 20, 2008.

The ABC School sponsors a second raffle to benefit a second division of The ABC School (e.g., the football team) for which total raffle ticket sales are $10,000 and the interest accrued to date is $150, for a total of $10,150 in a sub-account account associated exclusively with that division (the football team) of the ABC School. For the second raffle, a drawing date is set at Mar. 22, 2008.

The ABC School also sponsors a third raffle to benefit a third division of The ABC School (e.g., the scholarship fund) for which total raffle ticket sales are $25,000 and the interest accrued to date is $400, for a total of $25,400 in a sub-account associated exclusively with that division (the scholarship fund) of the ABC School. For the third raffle, a drawing date is set at Mar. 25, 2008.

On each drawing date, the promoter 10 or a trustee acting as an agent of the promoter 10 is directed to process the revenue according to the terms and conditions of the fundraising or raffle venture in place between the promoter 10 and the ABC School as he raffle sponsor 20. For example, when a winner is selected in the second drawing on Mar. 22, 2008, the promoter/trustee 10 pays out or holds in a separate account the amount of $10,150, with ownership redefined to the new owner as follows:

Promoter 10 receives $250, which includes one percent (1%) of the raffle revenue collected from sales of raffle tickets ($10,000)+$150 of earned interest; The second division (the football team) of The ABC School receives $4,950, which is determined by taking fifty percent (50%) of the raffle revenue ($10,000) minus one percent (1%) paid to the promoter 10; and

The raffle winner receives $4,950, which is determined by taking fifty percent (50%) of the raffle revenue ($10,000) minus one percent (1%) paid to the promoter 10.

It should be appreciated that the money flow process is expected to create a non-taxable event for the raffle ticket buyers since the raffle tickets are purchased from a not-for-profit institution, while the accounting service is being provided by the promoter 10.

In one embodiment, the promoter 10 establishes a national based drawing as well. In addition to the above, raffle ticket buyers have the ability to enter a national drawing and, on the drawing date, the buyer and the associated raffle sponsor 20 are declared as winners.

It should be appreciated that perceived advantages of the present invention are seen to include providing a highly efficient fundraising method, e.g., a fundraising method that requires less effort by a raffle sponsor than prior art methods. In addition, an Internet-based embodiment is designed to be highly entertaining and valuable to the end customers. For example, the invention is particularly well-suited to raising funds for schools because it does not require expressly involve students or require them to solicit door-to-door. Moreover, the raffle rewards (e.g., cash or retail products) may be selected to enhance key values such as, for example, health food products that do not including sugar-based products such as candy which have heretofore dominated certain school fundraisers. Preferably, the retail products are selected to not include “extreme margin—low value” products (which are often regarded as “junk” by customers).

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A method for raising funds for a raffle sponsor, comprising
forming a raffle venture with a raffle sponsor;
forwarding offers to sell raffle tickets to third parties;
collecting raffle revenue from raffle ticket buyers in exchange for raffle tickets;
holding a drawing to identify a raffle winner; and
distributing at least part of the raffle revenue as a jackpot to the raffle winner and as gain to the raffle sponsor according to the terms of the raffle venture.

2. The method of claim 1, wherein the raffle venture has a stated duration, the method comprising holding a plurality of raffles during the stated duration of the raffle venture.

3. The method of claim 1, further comprising offering promotional materials relating to the raffle to the raffle sponsor to assist the raffle sponsor in promoting the raffle.

4. The method of claim 1, comprising offering a bonus raffle ticket to raffle ticket buyers in exchange for attainment by raffle ticket buyers of a stated goal.

5. The method of claim 4, wherein the stated goal relates to academic performance, participation in selected activities, compliance with health criteria.

6. The method of claim 1, comprising receiving a promotion list of sponsor contacts from the raffle sponsor and sending to sponsor contacts offers for raffle tickets.

7. The method of claim 6, further comprising conveying other offers and/or information to the sponsor contacts.

8. The method of claim 1, further comprising recording personal profile information about raffle ticket buyers.

9. The method of claim 8, further comprising using the personal profile information to selected raffle ticket buyers as recipients of an offer and/or information unrelated to the raffle.

10. The method of claim 1, comprising setting an initial revenue-sharing factor as a term of the raffle venture.

11. The method of claim 10, comprising adjusting the revenue-sharing factor according to the terms of the raffle venture.

12. The method of claim 11, further comprising investing the revenue in an income-generating vehicle before holding the drawing.

13. An internet-based method for raising funds for a raffle sponsor, the method comprising:
providing a fundraiser website via the internet, wherein the fundraiser website is configured to form a raffle venture with a raffle sponsor, and to offer raffle tickets to third parties, and to collect raffle revenue from raffle ticket buyers in exchange for raffle tickets.

14. The method of claim 13, receiving from the raffle sponsor a promotion list of sponsor contacts having email addresses, and sending to sponsor contacts one or more promotional messages for raffle tickets via email.

15. The method of claim 14, comprising sending one or more promotional messages composed by the raffle sponsor.

16. The method of claim 14, comprising allowing a raffle sponsor to preview and edit a promotional message before sending the promotional message to sponsor contacts.

17. The method of claim 14, comprising adjusting the revenue distribution proportion value according to the terms of the raffle venture.

18. The method of claim 13, wherein the fundraiser website is configured to establish the raffle sponsor web page.

19. The method of claim 18, comprising receiving from the raffle sponsor an upload of content for the raffle sponsor web page.

20. The method of claim 13 comprising providing one or more of a blog site, an online social networking site and a webcast of the drawing.

21. The method of claim 13 comprising storing a revenue-sharing factor of the raffle venture.

22. The method of claim 21, comprising adjusting the revenue-sharing factor according to the terms of the raffle venture.
